(19) United States
(12) Patent Application Publication
(10) Pub. No.: US 2005/0224115 A1
(43) Pub. Date: Oct. 13, 2005

(54) Faucet with constant temperature valve

(75) Inventor: Shiao Lun-Jung, Taichung (TW)

Correspondence Address: TROXELL LAW OFFICE PLLC, Suite 1404, 5205 Leesburg Pike, Falls Church, VA, 22041, US

(73) Assignee: Globe Union Industrial Corp.

(21) Appl. No.: 10/820,764

(22) Filed: Apr. 9, 2004

(51) Int. Cl. G05D 11/00

(52) U.S. Cl. 137/100

(57) ABSTRACT

A constant temperature valve used in a faucet has a sleeve, an actuator and a plurality of separate spring rings. A plurality of O-shaped rubber rings is distributed longitudinally on an outer peripheral of the sleeve and divides the outer peripheral of the sleeve into a plurality of sections. The actuator forms a plurality of collars on a peripheral thereof for fitting with sections of the sleeve. A plurality of grooves is defined in an outer peripheral of the collars of the actuator for retaining the spring rings. Each spring ring forms a gap for enhancing resiliency thereof. The spring rings shrink appropriately to facilitate the actuator slidable relative to the sleeve 1 when dirty or hair is filled between the actuator and the sleeve. Thus, the constant temperature valve accurately responds to temperature control requirement. On the other hand, the spring rings and the grooves allow to lower manufacture precision requirement of the actuator and sleeve.

### BACKGROUND OF THE INVENTION

1. Field of the Invention

The present invention relates to a faucet, and particularly to a faucet with a constant temperature valve to control water temperature.

2. Related Art

Faucets are of a variety of types and shapes, and especially in modern times more styles are designed. Of course, above all, people always endeavor to design safe products, for instance, faucets preventing from scald. In the art, faucets with all kinds of structures preventing from scald are put into market.

Referring to FIGS. 5 and 6, a conventional constant temperature valve used in a faucet 4′ is illustrated to be mounted where hot and cool water joins, and by means of the constant temperature valve maintains pressure of hot and cool water balance, and controls water temperature, preventing that only hot water flows out thereby avoiding scald.

The conventional constant temperature valve includes a sleeve 1′ mounted on the valve 4′, and an actuator 3′ telescopically mounted on the sleeve 1′. However, in order to allow the actuator 3′ easily sliding relative to the sleeve 1′, the cooperation precision therebetween has to meet a certain requirement, so manufacture cost of high precision products cannot decrease. On the other hand, for meeting requirement of high cooperation precision, the interval between the actuator 3′ and the sleeve 1′ is small. Thus, as shown in FIGS. 7 and 8, the actuator 3′ tends to be stopped by dirty or hair, resulting in improper response of temperature control.

### SUMMARY OF THE INVENTION

Accordingly, an object of the present invention is to provide a constant temperature valve of a faucet, which allows to lower manufacture precision requirement thereby decreasing manufacture cost.

Another object of the present invention is to provide a constant temperature valve of a faucet, which always properly responds to temperature control.

The constant temperature valve of the present invention comprises a sleeve, an actuator and a plurality of separate spring rings. The sleeve is cylindrical and hollow and is mounted on a faucet in assembly. A plurality of O-shaped rubber rings is distributed longitudinally on an outer peripheral of the sleeve and divides the outer peripheral of the sleeve into a plurality of sections. The actuator forms a plurality of collars on an outer peripheral thereof for fitting with sections of the sleeve. A plurality of grooves is defined in an outer peripheral of the collars of the actuator for retaining the spring rings. Each spring ring forms a gap for enhancing resiliency thereof. The diameters of outer peripherals of the spring rings are slightly larger than the diameter of an inner peripheral of the sleeve. The diameters of inner peripherals of the spring rings are slightly larger than the diameters of inner peripherals of the grooves of the actuator.

### BRIEF DESCRIPTION OF THE DRAWINGS

FIG. 1 is an exploded view of a constant temperature valve of the present invention.

FIG. 2 is a cross-sectional view taken along the line 2-2 in FIG. 1.

FIG. 3 is a partially enlarged view of the constant temperature valve of FIG. 2.

FIG. 4 is another partially enlarged view of the constant temperature valve of FIG. 2.

FIG. 5 is an exploded view of a conventional constant temperature valve.

FIG. 6 is an exploded view of the conventional constant temperature valve of FIG. 5 and a part of a faucet.

FIG. 7 is a cross-sectional view taken along the line 7-7 in FIG. 5.

FIG. 8 is a partially enlarged view of the conventional constant temperature valve of FIG. 7.

### DESCRIPTION OF THE PREFERRED EMBODIMENTS

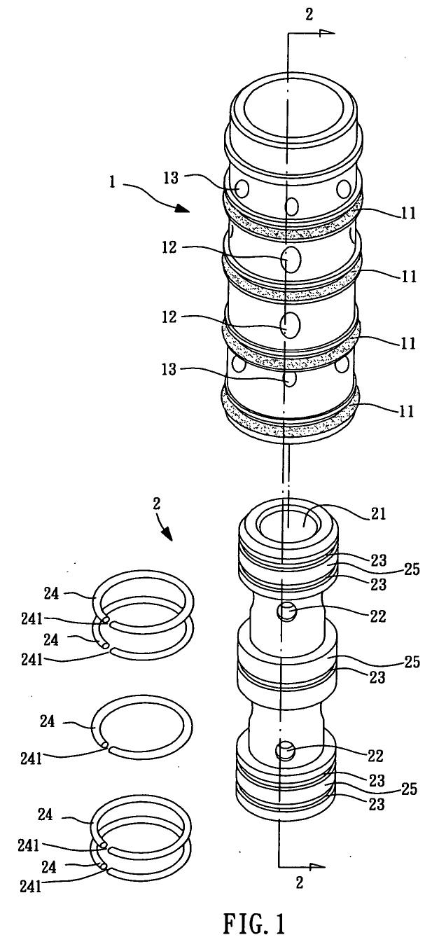

With reference to FIG. 1, a constant temperature valve in accordance with the present invention comprises a sleeve 1, an actuator 2 and a plurality of separate spring rings 24.

The sleeve 1 is cylindrical and hollow and is mounted on a faucet 4 in assembly. A plurality of O-shaped rubber rings 11 is mounted around the sleeve 1. The rubber rings 11 are distributed longitudinally on an outer peripheral of the sleeve 1 and divide the outer peripheral of the sleeve 1 into a plurality of sections. Each section defines a plurality of inlet holes 12 and outlet holes 13 for water inlet and outlet.

The actuator 2 is telescopically mounted in the sleeve 1 with interval therebetween. The actuator 2 forms a plurality of collars 25 on a peripheral thereof for fitting with sections of the sleeve 1. A pair of cavities 21 is respectively defined in opposite ends of the actuator 2 for providing water pressure to pull the actuator 2. A plurality of through holes 22 is defined in the peripheral of the actuator 2 and communicates with the cavities 21 for allowing water to flow into the cavities 21.

A plurality of grooves 23 is defined in an outer peripheral of the collars 25 of the actuator 2 for retaining the spring rings 24. Each spring ring 24 forms a gap 241 for enhancing resiliency thereof.

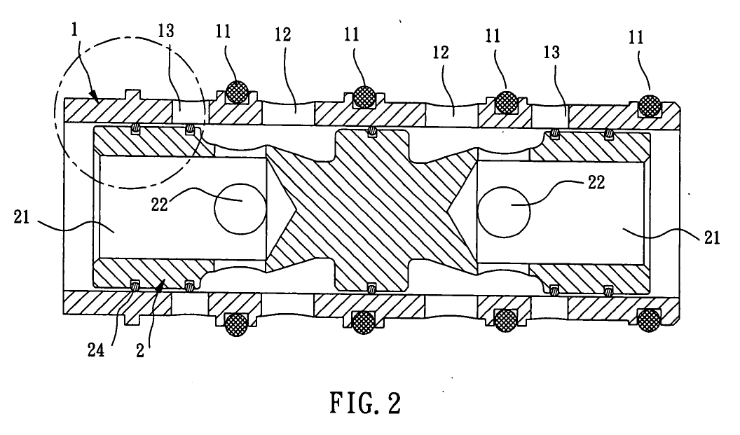

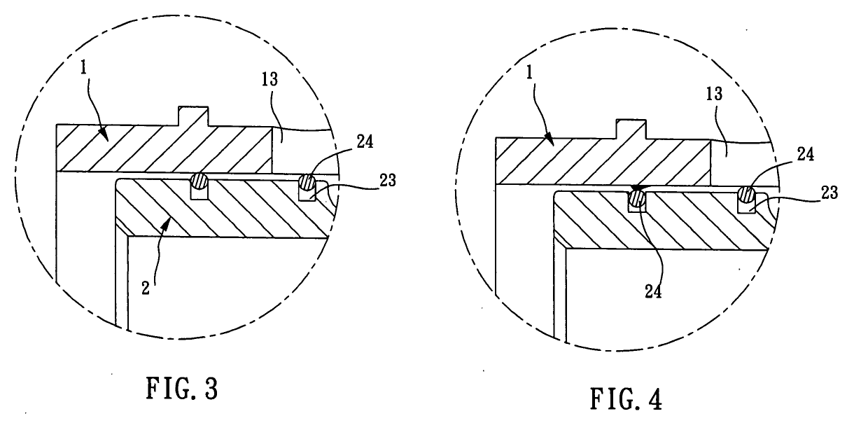

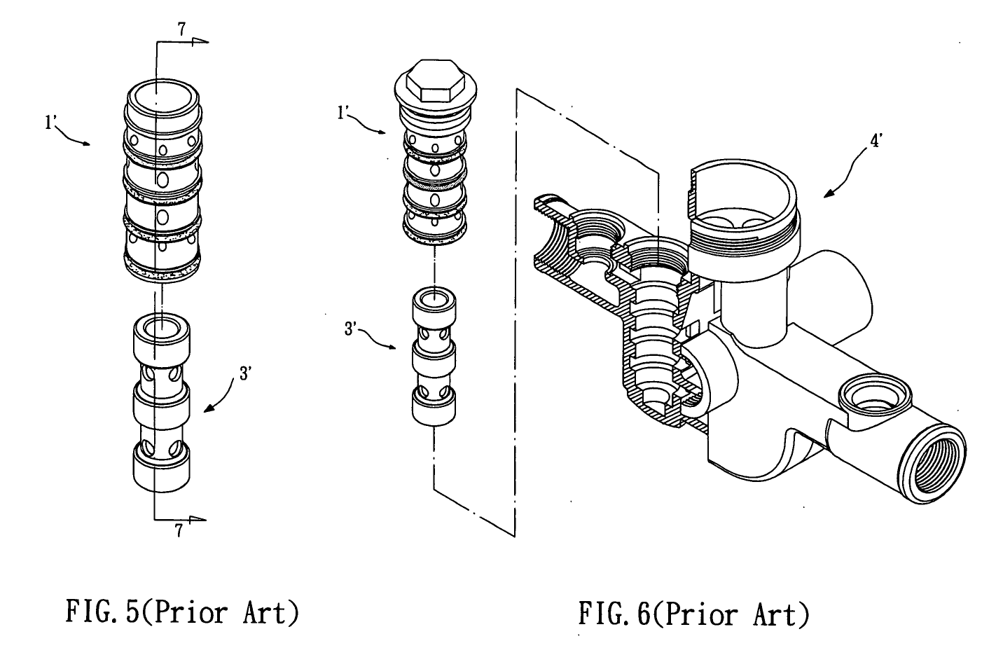

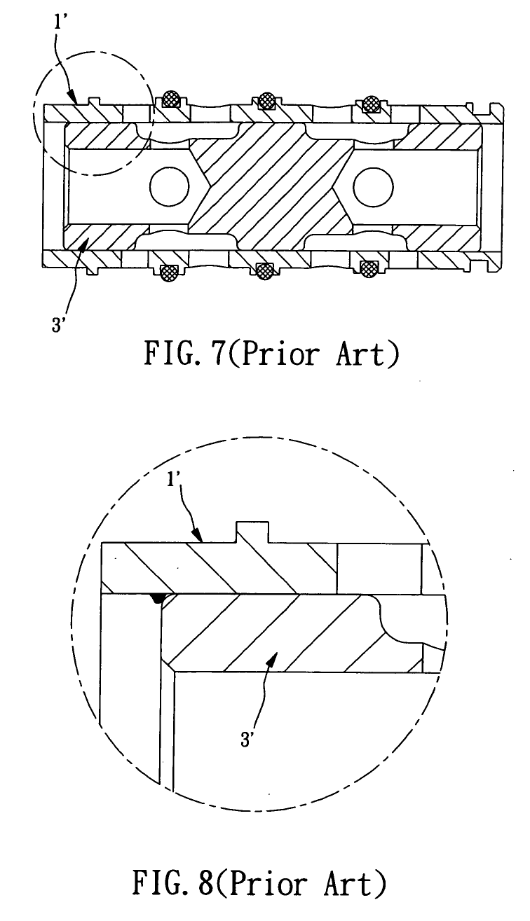

Further referring to FIGS. 2 and 3, the diameters of outer peripherals of the spring rings 24 are slightly larger than the diameter of an inner peripheral of the sleeve 1. The diameters of inner peripherals of the spring rings 24 are slightly larger than the diameters of inner peripherals of the grooves 23 of the actuator 2. The diameters of the spring rings 24 are slightly changeable because of the gaps 241.

In assembly, the spring rings 24 are received in the grooves 23 of the actuator 2. The actuator 2 is slidably received in the sleeve 1, and the collars 25 are fitted to inner peripherals of the sleeve 1. As shown in FIG. 4, the spring rings 24 shrink appropriately to facilitate the actuator 2 slidable relative to the sleeve 1 when dirty or hair is filled between the actuator 2 and the sleeve 1. Thus, the constant temperature valve accurately responds temperature control requirement. On the other hand, the spring rings 24 between the actuator 2 and the sleeve 1 reduce resistance force of the actuator 2 when the actuator 2 moves relative to the sleeve 1. Moreover, due to resiliency of the spring rings 24, the spring rings 24 received in the grooves 23 allow to lower manufacture precision requirement of the actuator 2 and sleeve 1.

It is understood that the invention may be embodied in other forms without departing from the spirit thereof. Thus, the present examples and embodiments are to be considered in all respects as illustrative and not restrictive, and the invention is not to be limited to the details given herein.

1. A constant temperature valve used in a faucet, comprising:
a sleeve being mountable on the faucet and being cylindrical and hollow, a plurality of O-shaped rubber rings being distributed longitudinally on an outer peripheral of the sleeve and dividing the outer peripheral of the sleeve into a plurality of sections;
an actuator being telescopically mounted in the sleeve with interval therebetween, and forming a plurality of collars on an outer peripheral thereof for fitting with sections of the sleeve, a plurality of grooves being defined in an outer peripheral of the collars; and
a plurality of spring rings being received in the grooves of the actuator.

2. The constant temperature valve as claimed in claim 1, wherein each spring ring forms a gap for enhancing resiliency thereof.

3. The constant temperature valve as claimed in claim 1, wherein the diameters of outer peripherals of the spring rings are slightly larger than the diameter of an inner peripheral of the sleeve, and wherein the diameters of inner peripherals of the spring rings are slightly larger than the diameters of inner peripherals of the grooves of the actuator

4. The constant temperature valve as claimed in claim 1, wherein a pair of cavities is respectively defined in opposite ends of the actuator for providing water pressure to pull the actuator, and wherein a plurality of through holes is defined in the peripheral of the actuator and communicates with the cavities for allowing water to flow into the cavities.

5. The constant temperature valve as claimed in claim 1, wherein each section of the sleeve defines a plurality of inlet holes and outlet holes for water inlet and outlet.
